(19) United States
(12) Patent Application Publication
(10) Pub. No.: US 2021/0337902 A1
(43) Pub. Date: Nov. 4, 2021

(54) FACE SHIELD AND METHOD OF MAKING THE SAME

(71) Applicant: Lifethereal LLC, Gorham, ME (US)

(72) Inventor: Charles Friedman, Portland, ME (US)

(73) Assignee: Lifethereal LLC, Gorham, ME (US)

(21) Appl. No.: 16/863,176

(22) Filed: Apr. 30, 2020

(51) Int. Cl. A41D 27/24; A41D 13/11; B29C 65/72

(52) U.S. Cl. CPC A41D 27/24; B29C 65/72; A41D 13/1184; A41D 13/1161

(57) ABSTRACT

A method of making a face shield using a bar tack stitch to join a face shield lens to a backing. The backing may be a headband or the combination of the headband and a cushion. The lens and the optional cushion may be joined together and then the lens may be stitched to the cushion and the headband. A bar tack stitch may be used to join the backing and lens together. Stitching the lens to its backing produces a novel face shield with high quality structural integrity that can be made quickly and cost effectively to eliminate limitations associated with bonded face shield lenses and removable joined face shield lenses.

### BACKGROUND OF THE INVENTION

### 1. Field of the Invention

The present invention relates to face shields. More particularly, the present invention relates to an efficient method of making face shields having substantial attachment integrity as well as the resulting novel face shield.

### 2. Description of the Prior Art

Face shields are an important portion of personal protective equipment used to protect individuals who may otherwise come in contact with hazardous substances, including chemical and biological substances such as viruses but not limited thereto. Recent events have magnified the need for face shields with the rise of a pervasive pandemic involving a highly contagious virus rendering them even more essential. Whereas prior conditions around the world resulting in the usage of face shields have largely been met by existing inventory, manufacturing capacity and product transport capabilities, current events have taxed all three pillars of face shield availability. The result is an “all hands onboard” need to substantially increase manufacturing capacity.

There now exists a wide range of face shield manufacturers, some with substantial relevant manufacturing history and others learning how to make satisfactory ones as quickly as possible. The components of the face shield are fairly simple and minimal. The components are the face shield lens and a headband, and, optionally, a cushion, also referred to as a forehead bumper, positioned between the lens and the headband. The cushion when used is attached on one of its sides to the lens and on the opposing side to the headband. The lens width is usually substantially equal to the length of the headband and typically extends from ear-to-ear on the upper portion of the wearer's head when in use.

A user places the headband around his or her head at the forehead, with the interior surface of the lens adjacent to the user's face but may be spaced away from it by the cushion if that forms part of the face shield. The exterior surface of the lens is a protective surface that blocks particulate matter in the environment from contacting the user's face. The face shield lens is transparent and made of a nonmetallic material, such as a plastic that may be, but is not limited to polyethylene terephthalate (PET). The lens should be flexible enough to have some give and to enable a curved shape when joined to the headband and/or cushion. The lens is generally configured to extend radially about the user's face, ending at both sides about at the user's ears. Optionally, the lens is joined to the headband (or to the cushion and possibly also to the headband if a cushion forms part of the face shield) in a manner that allows it to lay flat when not in use to minimize space consumption and thereby maximize packing for transport.

A problem with existing face shields relates to their method of manufacture rather than to the characteristics of the face shield necessary to protect the user from the contact of hazardous substances with their face. In particular, current methods of face shield manufacture involve either the permanent attachment of the lens to the cushion with an adhesive, or the removable attachment of the lens to the cushion using lens ports that sit on cushion tabs extending from the outer surface of the cushion.

For the face shield that has the lens permanently bonded, it is necessary to wait precious time for that adhesive to set before the face shield can be completed. The glue setting can be accelerated using an accelerant, such as ultraviolet light, but that takes time and adds a step and an expense to the manufacturing process. Additionally, the integrity of the adhesive bond between the lens and the cushion may be compromised by the integrity of the adhesive, the quantity applied between the two materials, the location of adhesive application, and the general concern of bonding disparate materials together.

The lag in manufacturing time and adhesive bond integrity uncertainty reduce the efficiency of face shield manufacturing and the reliability of the resulting face shields. Neither limitation is desirable at any time, but particularly when output and quality maximization is critical. In addition, it should be noted that while high quality rapid product throughput is essential, it is also important that the face shields be made in a cost-effective manner to minimize expenses to all consumers.

For the face shield that has the lens removably joined to the headband and/or to the optional cushion, it is necessary to make or modify the lens with the hook ports, ensuring alignment with the headband or cushion tabs, and it is necessary to make or modify the cushion to include the tabs. Both components require additional manufacturing steps than when using adhesive. In addition, there exists the concern that the lens can be dislodged from the headband/cushion when in use, resulting in an undesirable and potentially dangerous condition. Also, this option requires assembly by the consumer if there is an interest in shipping it disassembled to maximize product packing for transport.

Therefore, what is needed is an improved method of making face shields. What is also needed is an improved method of making face shields of high quality and integrity. Further, what is needed is an improved method of making face shields that is cost effective and results in the fabrication of a face shield product of desirable integrity.

### SUMMARY OF THE INVENTION

It is an objective of the present invention to provide an improved method of making face shields. It is also an objective to provide an improved method of making face shields of high quality and integrity. Further, it is an objective of the present invention to provide an improved method of making face shields that is cost effective and that results in a face shield product of desirable integrity. Further still, it is an objective to allow the face shield to be efficiently shipped without requiring user assembly.

These and other objectives are achieved with the present invention, which is an improved method of making face shields. The invention involves the joining of the lens to the headband, the optional cushion, or both using stitching rather than an adhesive only. The stitching may be sewn in place using a suitable stitch form sufficient to maintain structural integrity for the intended usage of the face shield. It has been observed that the bar tack stitch is a suitable stitch for producing high quality, high integrity face shields in a cost-effective manner but that is not the only suitable stitch type. The use of stitching in making face shields results in a novel face shield product that secures the lens in place without the concern associated with adhesive bonding alone of the lens.

A stitch such as a bar tack stitch has been used to reinforce areas of garments, such as pocket openings, for example. The bar tack stitch has thus been used primarily to reinforce a garment material rather than primarily to join two pieces together, particularly pieces of different material types. The bar tack stitch may be sewn by hand such as by using whip stitches, but for the purpose of manufacturing efficiency and certainty can be sewn by machine using zigzag stitches. The bar tack established with bar tack stitching is accomplished by sewing narrowly-spaced “bar” stitches in a selectable direction and then sewing a series of stitches of selectable length across the bar stitches, such as in a zigzag or perpendicular arrangement that secures the bar in place. The cross stitching tacks the bar in place, thereby preventing the bar stitch from releasing or loosening. Again, however, other stitch configurations are possible without deviating from the invention.

The manufacturing method of the present invention includes steps for making a face shield of suitable dimensions and structural characteristics. The primary step of the method involves joining a face shield lens to its backing by stitching, whether that backing is a headband alone or a headband and cushion combination. For the face shield including a cushion, there are four method options. First, the cushion may be attached to the lens, such as with a woven fabric with a pressure sensitive adhesive backing that extends for a portion of the length of the cushion, an adhesive that may exist on the cushion 104, or both, and the headband and cushion stitched to the lens. Second, the lens may be stitched to the headband and the cushion joined to the headband by any joining means including but not limited to an adhesive. Third, the lens may be stitched to the cushion alone and the cushion joined to the headband, such as with an adhesive or other means. Fourth, the lens may be stitched to the cushion and to the headband without using a supplemental joining means such as the woven fabric with pressure sensitive adhesive backing. It is to be understood that any of those methods may include use of a supplemental bonding means such as a woven fabric with a pressure sensitive adhesive backing, for example, to supplement the attachment of the lens to the headband and/or the cushion. The stitching of the lens to its backing may be a bar tack stitching but not limited thereto.

The lens is stitched to the backing along a substantial portion of the width of the backing at both ends thereof. That stitching arrangement ensures a high integrity attachment of the headband to the lens while keeping the headband opening as wide as possible for comfortable and secure placement about the wearer's head. The lens may alternatively be joined to its backing along the entire width of the lens so that it remains in a curved configuration at all times; however, that stitching arrangement should only be used when the backing is the optional cushion only and the headband is separately secured at its ends to the lens/cushion combination. The optional cushion may be attached to the lens in alignment with the headband or it may simply be wedged into a space between the headband and the lens in the forehead area. Stitching the lens to the backing ensures that the face shield can be densely packed while fully assembled for efficient shipping and ready to use upon arrival at destination.

The face shield manufactured with the method of the present invention produces a novel face shield in the form of a face shield having a lens attached by stitching to its backing, which may be the headband, the cushion or the headband and cushion. The method of the present invention is a cost-effective way to produce face shields quickly, wherein the face shields so produced are of substantial quality and structural integrity. The advantages of the method of the present invention and the associated face shield will be further apparent upon review of the following detailed description, the appended claims and the accompanying drawings.

### BRIEF DESCRIPTION OF THE DRAWINGS

FIG. 1 is a simplified flow diagram showing primary steps of the face shield manufacturing method of the present invention.

FIG. 2 is a side perspective view of a novel face shield produced using the manufacturing method of the present invention.

FIG. 3 is a plan view of an example bar tack stitch that may be used in the method of the present invention.

FIG. 4 is a plan view of an example bar stitch that may be used in the method of the present invention.

FIG. 5 is a front perspective view of the novel face shield produced using the manufacturing method of the present invention in position on a user.

### DETAILED DESCRIPTION OF THE INVENTION

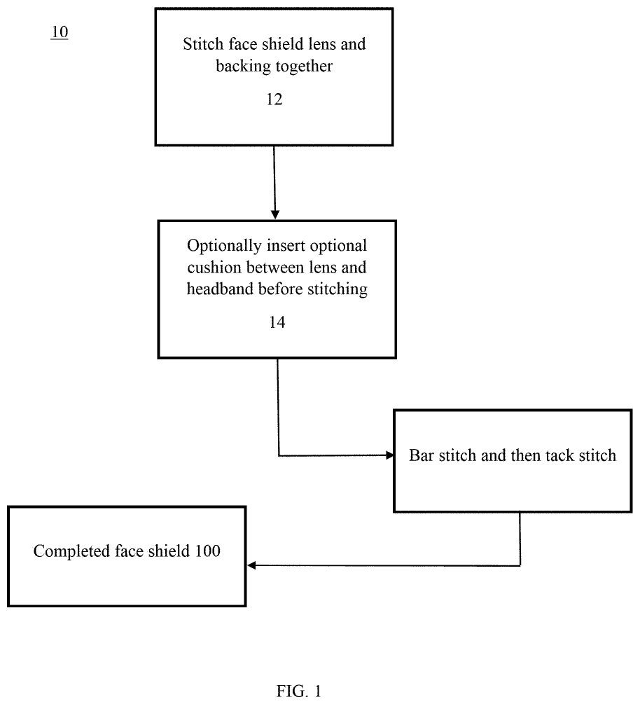

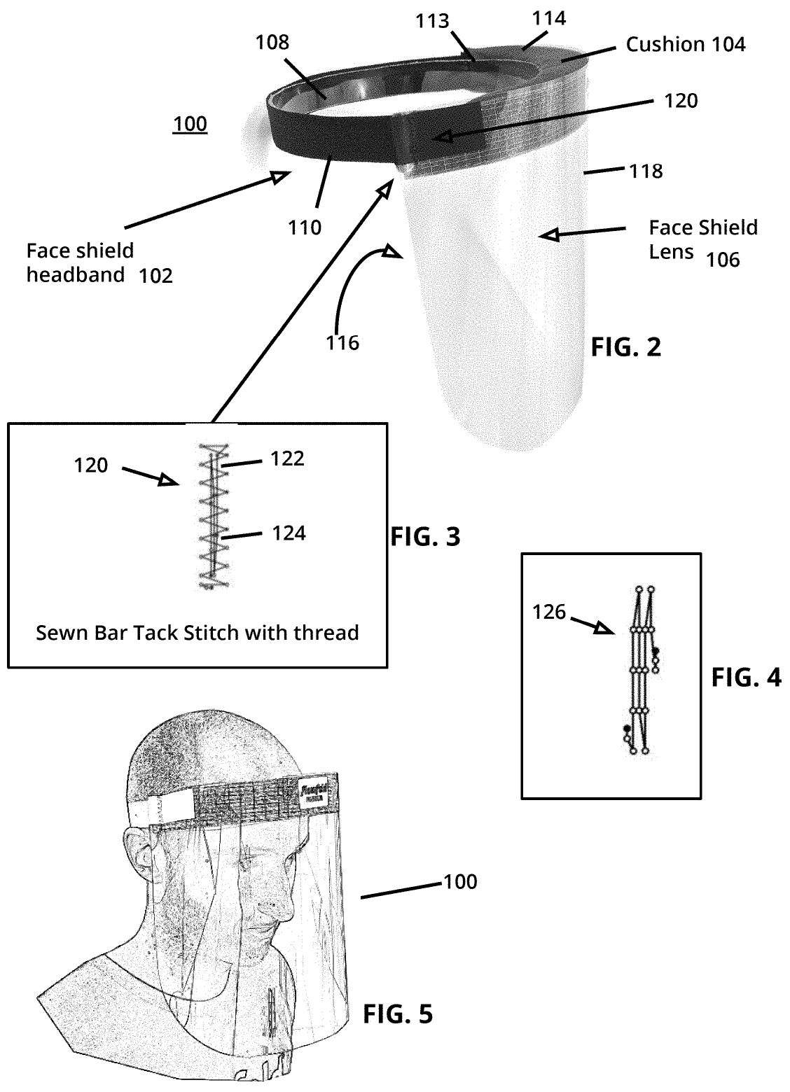

FIG. 1 shows primary steps of a method 10 of the present invention for making a novel face shield 100 shown in FIGS. 2 and 5. The face shield 100 includes a headband 102, an optional cushion 104, which also may be referred to as a forehead bumper, and a face shield lens 106. The headband 102 has an interior surface 108 and an exterior surface 110. The cushion 104 has an interior surface 112 and an exterior surface 114. The lens 106 has an interior surface 116 and an exterior surface 118. The lens 106 also has an upper section 120. The interior surface 108 of the headband 102 is in contact with a wearer's face, and the exterior surface 118 of the lens is in contact with the outer environment when the face shield 100 is in use. It is to be understood that a version of the invention results in the fabrication of a face shield without the cushion 104.

The headband 102 is preferably made of an elastic material such as rubber or an elasticized fabric. It is sized and shaped to remain snugly engaged about the upper portion of the head of a wearer and that can be easily removed by stretching and pulling the headband 102. The optional cushion 104 is preferably made of a compressible material such as an open-cell or closed-cell foam but is not limited thereto. The cushion 104 is chosen to provide comfort to the wearer at the forehead region and primarily in the vicinity of the lens 106. It may be as wide as the headband 102 or of a different width. The cushion 104 is also chosen of sufficient thickness that even when partially compressed maintains the lens 106 in a position that it stands off from and does not come in contact with the wearer's face. The face shield lens 106 is preferably made of PET but is not limited thereto. The face shield lens 106 is of selectable thickness chosen to ensure that the face shield 100 protects as desired for the particular application. The face shield lens 106 should be transparent enough to see through and may or may not be clear. The width of the lens 106 is about the same as the length of the headband 102, and the length of the lens 106 is substantially longer than the width of the headband 102. Components 102, 104 and 106 of the face shield 100 are of the type generally known and used by those of skill in the art of the production of face shields.

The method 10 of the present invention for making the face shield 100 includes step 12 of joining the lens 106 to its backing by stitching the two together. The backing may be the headband 102 alone, the optional cushion 104 alone, or the combination of the headband 102 and the optional cushion 104. The stitching is applied to the lens 106 and the backing when the two are aligned together as desired. When the lens 106 and the headband 102 are stitched together, either with or without the cushion 104, the stitching is carried out along a substantial portion of the width of the headband 102 near both ends thereof, with little of the length of the headband 102 stitched. When the lens 106 is only stitched to the cushion 104, the stitching may be carried out along a portion or substantially all of the length of the cushion 104. When the face shield 100 includes the cushion 104, the method includes step 14 of adding the cushion 104 to the headband 102 and the lens 106. Step 14 may be carried out by joining the cushion 104 to the lens 106 on the interior surface 116 thereof using an adhesive, stitching or other joining means. Alternatively, step 14 may be carried out by joining the cushion 104 to the lens as part of step 12. Optionally, the cushion 104 may be made part of the face shield 100 by stitching the headband 102 and the lens 106 together at portions thereof and leaving a gap between the headband 102 and the lens 106 for insertion of the cushion therebetween.

Step 12 of the method 10 involves stitching the lens 106 to its backing, which may be the headband 102 or the headband 102 and the cushion 104 in combination. In an embodiment, the stitch used to join the lens 106 and its backing together is a bar tack stitch, such as bar tack stitch 120 shown in FIG. 3. The bar tack stitch 120 includes a bar stitch 122 and a tack stitch 124. The bar stitch 122 is first sewn by stitching through the exterior surface 118 and interior surface 116 of the lens 106 and through the backing. Next, the tack stitch 124 is sewn over the bar stitch 122 by stitching through the exterior surface 118 and interior surface 116 of the lens 106 and through the backing. The tack stitch 124 may be of a zigzag configuration as shown in FIG. 3, or it may be of a different angle, such as substantially perpendicular to the bar stitch 122.

In another embodiment, the stitching may be a bar stitch such as the bar stitch 126 shown in FIG. 4. The bar stitch 126 is sewn by stitching through the exterior surface 118 and interior surface 116 of the lens 106 and through the backing. Either or both of the bar tack stitch 120 and the bar stitch 126 may be used with a supplementary joining component, such as a woven fabric with a pressure sensitive adhesive backing, for example. In addition, either or both of the bar tack stitch 120 and the bar stitch 126 may be sewn at any desired location where the lens 106 and its backing are in contact with one another. For example, the stitching may be sewn across the entirety of the contact area or it may be selectively sewn in areas of interest including, but not limited to, edges of the area.

The use of stitching in the method 10 of making the face shield 100 of the present invention enables certainty of the joining of the lens 106 to its backing, whether that backing is the headband 102, the cushion 104 or the combination of the headband 102 and the cushion 104. Stitching can be done easily and quickly using conventional sewing equipment, such as the Brother KE-430HS Bar Tacker but not limited thereto, with no delays or uncertainties of the type associated with adhesive alone joining or removable hook-and-port attachment options. As shown in FIG. 5, the resultant novel face shield 100 with stitching is suitable for use by a wearer in a conventional manner. It is to be noted that the order of steps may be changed without deviating from the invention in regard to the order in which the lens 106 is joined to its backing before or after including the optional cushion 104.

The present invention has been described using specific examples. It is not intended to be limited thereto but instead is defined by the appended claims and reasonable equivalents.

What is claimed is:

1. A method of making a face shield having a backing and a face shield lens, the method comprising the step of:
stitching the face shield lens to the backing.

2. The method of claim 1 wherein the backing is a headband.

3. The method of claim 2 wherein the backing is a headband and a cushion.

4. The method of claim 3 further comprising the step of joining the cushion to the lens before stitching the face shield lens to the headband and the cushion.

5. The method of claim 1 wherein the step of stitching the face shield lens to the backing includes stitching the lens to the backing using a bar tack stitch.

6. The method of claim 5 wherein the step of stitching using the bar tack stitch to stitch the lens and the backing together includes first stitching a bar stitch and then stitching a tack stitch.

7. The method of claim 1 wherein the step of stitching the face shield lens to the backing involves stitching the face shield lens substantially an entire width of the backing at both ends thereof.

8. The method of claim 1 wherein the step of stitching the face shield lens to the backing involves stitching the face shield lens to a portion of the backing.

9. The method of claim 1 wherein the backing is a headband and a cushion, wherein the step of stitching involves stitching through the face shield lens, the cushion and the headband.

10. A face shield comprising:
a backing; and
a face shield lens,
wherein the face shield lens is stitched to the backing.

11. The face shield of claim 10 wherein the face shield lens is stitched to the backing with a bar tack stitch.

12. The face shield of claim 11 wherein the bar tack stitch formed of a tack stitch over a bar stitch.

13. The face shield of claim 10 wherein the face shield lens is made of a clear transparent plastic material.

14. The face shield of claim 10 wherein the backing is a headband.

15. The face shield of claim 10 further comprising a cushion.

16. The face shield of claim 15 wherein the cushion is positioned between the headband and the face shield lens.

17. The face shield of claim 16 wherein the face shield lens is stitched to the cushion and to the headband.

18. The face shield of claim 16 wherein the face shield lens is stitched only to the headband.

19. The face shield of claim 10 further comprising a woven fabric with a pressure sensitive adhesive backing between at least a portion of the face shield lens and the backing.
